(19) United States
(12) Patent Application Publication
(10) Pub. No.: US 2005/0217709 A1
(43) Pub. Date: Oct. 6, 2005

(54) Cleaning mechanism for an image sensor package

(76) Inventors: Reg Yang, Hsinchu Hsien (TW); Bird Lin, Hsinchu Hsien (TW); Channing Wel, Hsinchu Hsien (TW)

Correspondence Address: PRO-TECHTOR INTERNATIONAL, 20775 Norada Court, Saratoga, CA, 95070-3018, US

(21) Appl. No.: 10/816,334

(22) Filed: Mar. 31, 2004

(51) Int. Cl. B08B 3/04

(52) U.S. Cl. 134/113; 134/902; 134/200

(57) ABSTRACT

A cleaning mechanism for an image sensor package, the cleaning mechanism a seal up body is formed with a cleaning room. A substrate formed with frame layer is fixed on the top end of the cleaning room, then, the chamber of the substrate being faced down direction from the cleaning room. A cleaning device is mounted on the bottom end of the cleaning room for cleaning the chamber of the substrate by cleaner.

### BACKGROUND OF THE INVENTION

1. Field of the Invention

The invention relates to a cleaning mechanism for an image sensor package, and in particular to a mechanism for efficiently and quickly cleaning an image sensor in package processes, so as to increase the production yield.

2. Description of the Related Art

Referring to FIG. 1, a conventional image sensor includes a substrate 10, a frame layer 18, a photosensitive chip 26, a plurality of wires 28, and a transparent layer 34. The substrate 10 has a first surface 12 on which a plurality of signal input terminals 15 is formed, and a second surface 14 on which a plurality of signal output terminals 16 is formed. The frame layer 18 has an upper surface 20 and a lower surface 22 adhered to the first surface 12 of the substrate 10 to form a chamber 24 together with the substrate 10. The photosensitive chip 26 is arranged within the chamber 24 and is mounted to the first surface 12 of the substrate 10. Each wire 28 has a first terminal 30 and a second terminal 32. The first terminals 30 are electrically connected to the photosensitive chip 26, and the second terminals 32 are electrically connected to the signal input terminals 15 of the substrate 10. The transparent layer 34 is adhered to the upper surface 20 of the frame layer 18.

In order to finish the above-mentioned package processes, the chamber 24 of the substrate 10 has to be efficiently cleaned, so as to decrease the particle.

Please refer to FIG. 2, is a traditional method of cleaning mechanism for an image sensor package includes a body element 40, a rotating device 42, and a cleaning device 44.

The body element 40 is formed with a chamber 46. The rotating device 42 is arranged within the chamber 46 of the body element 40. The cleaning device 44 is arranged within the chamber 46 of the body element 40 and is located on the upper end of the body element 40. So as to while the substrate 10 formed with frame layer 18 mounted on the rotating device 42, the chamber 24 of the substrate 10 is faced the cleaning mechanism 44, respectively, the cleaner of the cleaning mechanism 44 is to clean the chamber 46 of the substrate 10.

However, the conventional cleaning mechanism for cleaning an image sensor package has following drawbacks.

1. Since a right angle is formed between the substrate 10 and frame layer 18, so particle is easily hide in the right angle, thus, cleaner can not efficiently clean the chamber 24.

### SUMMARY OF THE INVENTION

An object of the invention is to provide a cleaning mechanism for an image sensor package, wherein the processes for packaging an image sensor may be efficiently cleaned, so as to increase the production yield.

To achieve the above-mentioned object, the invention provides a cleaning mechanism for an image sensor package, the cleaning mechanism is for cleaning the substrate and the frame layer arranged on the substrate of the image sensor to form a chamber between the frame layer and the substrate. The mechanism includes a seal up body is formed with a cleaning room, the substrate formed with frame layer is fixed on the top end of the cleaning room, then, the chamber is faced down direction of the cleaning room. A rotating device is located within the cleaning room of the seal up body. A cleaning device is mounted on the bottom end of the cleaning room of the seal up body, and is cleaned the chamber of the substrate by cleaner.

### BRIEF DESCRIPTION OF THE DRAWINGS

FIG. 1 is a cross-sectional view showing a conventional image sensor package.

FIG. 2 is a schematic illustrated showing a conventional cleaning mechanism for an image sensor package.

FIG. 3 is a schematic illustrated showing a cleaning mechanism for an image sensor package of the present invention.

FIG. 4 is a cross-sectional view showing a cleaning mechanism for an image sensor package of the present invention.

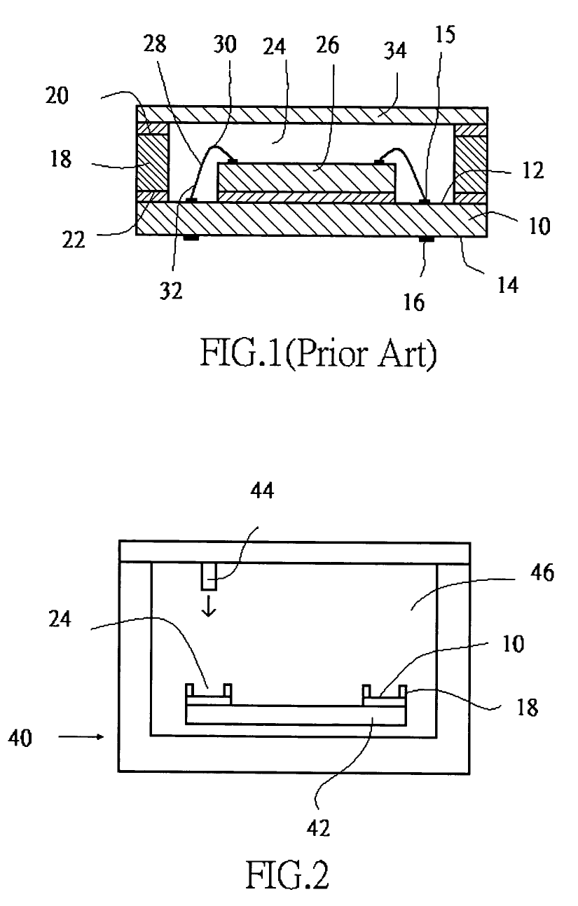

### DETAILED DESCRIPTION OF THE INVENTION

Please refer to FIG. 3. A cleaning mechanism for an image sensor of the present invention includes a seal up body 50, a cleaning mechanism 52, and a vacuum pump 54.

The seal up body 50 has a lower element 56, a periphery wall 58, and a upped cover 60 to form a chamber 62.

The cleaning device 54 is located within the cleaning room 62 of the seal up body 50, and mounted on the bottom end of the cleaning room 62 of the seal up body 50, the cleaning device 54 may be ejected the cleaner. In the embodiment, the cleaner is water or N2 or CO2.

The vacuum pump 54 is located within the cleaning room 62 of the seal up body 50 to absorb the cleaner and particle.

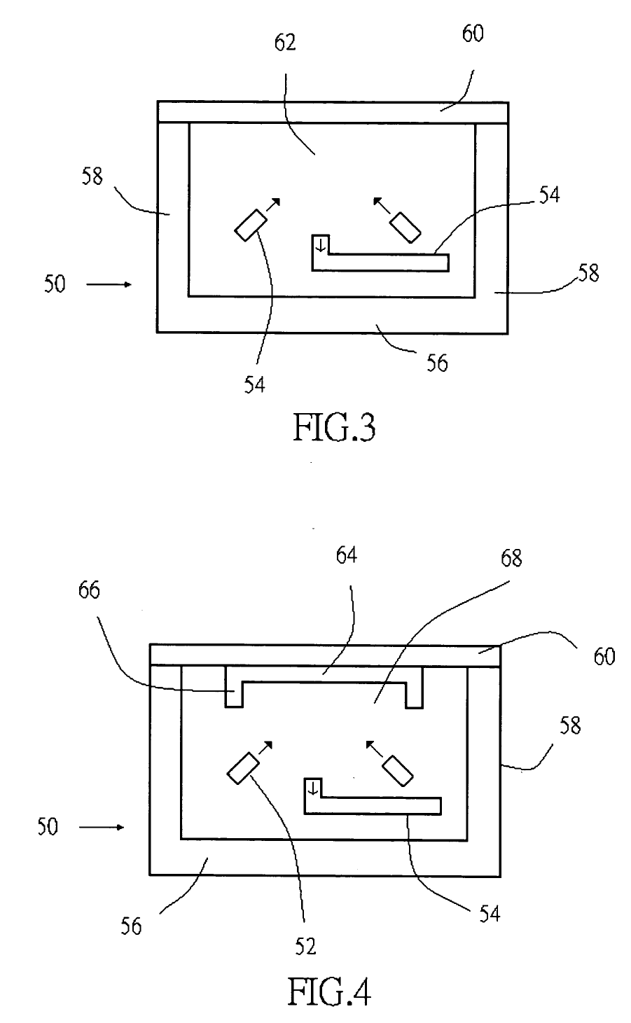

Please refer to FIG. 4, is a cross-sectional schedule showing a cleaning mechanism for an image sensor package. A substrate 64 is formed with a frame layer 66 for an image sensor package. A chamber 68 is formed between the substrate 64 and frame layer 66. The substrate 64 is located within the cleaning room 62, and is mounted on the top end of the seal up body 50, then, the chamber 68 is faced down direction of the cleaning device 50. Therefore, the cleaner from the cleaning device 54 is ejected to the chamber 68, so that may be cleaned the chamber 68 by cleaner.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

1. A cleaning mechanism for an image sensor package, the cleaning mechanism being cleaning the substrate and the frame layer arranged on the substrate of the image sensor to form a chamber between the frame layer and the substrate, the mechanism comprising:
a seal up body being formed with a cleaning room, the substrate formed with frame layer being fixed on the top end of the cleaning room, then, the chamber of the substrate being faced down direction from the cleaning room;
a cleaning device being mounted on the bottom end of the cleaning room of the seal up body for cleaning the chamber of the substrate by cleaner.

2. The cleaning mechanism according to claim 1, wherein seal up body includes a lower element, a periphery wall, and a upper cover.

3. The cleaning mechanism according to claim 1, wherein further includes a vacuum pump is arranged within the cleaning room.

4. The cleaning mechanism according to claim 1, wherein the cleaner of the cleaning device is N2 or CO2.

5. The cleaning mechanism according to claim 1, wherein the cleaner of the cleaning device is water.
